(19) United States
(12) Patent Application Publication
(10) Pub. No.: US 2008/0161952 A1
(43) Pub. Date: Jul. 3, 2008

(54) Audio data processing apparatus

(75) Inventors: Masataka Osada, Kawasaki-shi (JP); Hirokazu Takeuchi, Tokyo (JP); Kimio Miseki, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/810,995

(22) Filed: Jun. 7, 2007

(30) Foreign Application Priority Data
Dec. 27, 2006 (JP) P2006-352916

(51) Int. Cl. G06F 17/00; G10L 19/00; G10L 21/00

(52) U.S. Cl. 700/94; 704/201; 704/205

(57) ABSTRACT

According to an aspect of the invention, there is provided an audio data processing apparatus including: a decoding unit configured to decode audio encoding data, while the decoding unit switches an M/S stereo application mode and an M/S stereo non-application mode, and thereby outputting frequency domain audio data; an inverse quantizing unit configured to inversely quantize and output the frequency domain audio data; an M/S stereo judgment unit configured to decide whether or not the M/S stereo application mode is applied to the scale factor band, and extract and output a frequency domain audio data of the S channel at a part of scale factor band to which the M/S stereo application mode is applied, and generate and output a frequency domain audio data of the S channel at a part of scale factor band to which the M/S stereo application mode is not applied.

### CROSS-REFERENCE TO RELATED APPLICATIONS

This application is based on and claims the benefit of priority from the prior Japanese Patent Application No. 2006-352916, filed on Dec. 27, 2006; the entire contents of which are incorporated herein by reference.

### BACKGROUND

1. Technical Field

The present invention relates to audio data processing apparatus.

2. Description of Related Art

For example, an apparatus that generates a digest image by extracting desired images from sports programs such as professional baseball games has been conventionally available. Where recorded images are reproduced to generate the digest image, the apparatus analyzes the sound reproduced at the same time with the image, for example, on detection of cheers of spectators, extracting an image corresponding to the cheers of spectators as a highlight scene, thereby generating the digest image.

### SUMMARY

According to an aspect of the invention, there is provided an audio data processing apparatus including: a decoding unit configured to decode audio encoding data, upon input of the audio encoding data generated by encoding audio signals of L and R channels, while the decoding unit switches, depending on a correlation between an audio signal of L channel and an audio signal of R channel, an M/S stereo application mode of encoding an audio signal of a M channel which is a sum component of the audio signals of L and R channels and an audio signals of a S channel which is a difference component of the audio signals of the L and R channels and an M/S stereo non-application mode of encoding the audio signals of L and R channels by every scale factor band, and thereby generating and outputting frequency domain audio data that is an audio data on frequency axis; an inverse quantizing unit configured to inversely quantize and output the frequency domain audio data; an M/S stereo judgment unit configured to decide, based on the inversely quantized frequency domain audio data by every scale factor band, whether or not the M/S stereo application mode is applied to the scale factor band, the M/S stereo judgment unit configured to extract and output a frequency domain audio data of the S channel at a part of scale factor band to which the M/S stereo application mode is applied, the M/S stereo judgment unit configured to generate and output, based on a frequency domain audio data of the L and R channels, a frequency domain audio data of the S channel at a part of scale factor band to which the M/S stereo application mode is not applied; and a characteristics analyzing unit configured to analyze a characteristics of the audio encoding data based on the frequency domain audio data of the S channel.

### BRIEF DESCRIPTION OF THE DRAWINGS

In the accompanying drawings:

FIG. 1 is an exemplary block diagram illustrating a configuration of Audio data processing apparatus in Embodiment 1;

FIG. 2 is an exemplary block diagram illustrating a configuration of decoding apparatus;

FIG. 3 is an exemplary block diagram illustrating a configuration of Audio data processing apparatus in Embodiment 2; and

FIG. 4 is an exemplary block diagram illustrating a configuration of Audio data processing apparatus in Embodiment 3.

### DESCRIPTION OF THE EMBODIMENTS

Hereinafter, a description will be made for embodiments by referring to the accompanying drawings.

### (1) Embodiment 1

In the present embodiment, a microphone of the L (left) channel and that of the R (right) channel are disposed at predetermined position in various places such as a ball stadium or a concert hall as means for picking up sounds and voices. A microphone is also disposed at a play-by-play commentary booth for picking up voices of an announcer or a host (not illustrated).

The voice of the announcer input from the microphone disposed at the play-by-play commentary booth is overlapped respectively with the voice input from the microphone of the L channel and the voice input from the microphone of the R channel, and input into encoding apparatus (not illustrated).

In the above-described encoding apparatus, an audio encoding method such as AAC (Advanced Audio Coding) is adopted, by which audio signals of the L channel and those of the R channel with which the voice of the announcer is overlapped are respectively subjected to Huffman coding.

In this instance, the encoding apparatus finely divides the audio signals of the L channel and those of the R channel into a plurality of frequency bands (hereinafter, referred to as scale factor band (sfb)), thereby encoding each of the thus finely divided scale factor bands.

Incidentally, the encoding apparatus calculates a correlation value of the audio signal of the L channel and that of the R channel for each scale factor band, and encodes the audio signals of the L and R channels as they are if the calculated correlation value is lower than a predetermined threshold value (M/S stereo non-application mode).

In contrast, if the calculated correlation value is greater than a predetermined threshold value (M/S stereo application mode), the encoding apparatus selects M/S (mid/side) stereo as a stereo mode, generating audio signals of the M channel, which is a sum component of audio signals of the L and R channels and also generating audio signals of the S channel, which is a difference component of audio signals of the L and R channels with reference to the following formula (1):

$$M = \frac{L + R}{2} \\ S = \frac{L - R}{2} . \qquad ( 1 )$$

### It is noted that since the audio signals of the S channel are generated by calculating a difference component of audio signals of the L and R channels, voices of the announcer or the host are removed.

Then, the encoding apparatus performs encoding by the unit of scale factor band after audio signals of the L channel are replaced by those of the M channel and also audio signals of the R channel are replaced by those of the S channel.

Thereby, for example, where a correlation value between audio signals of the L channel and those of the R channel is great (similar in waveform), the audio signal of the S channel is substantially “0.” Therefore, as compared with a case where audio signals of the L channel and those of the R channel are encoded independently, redundant audio signals of the L and R channels can be removed to provide an efficient encoding.

The generated audio encoding data has audio encoding data of a first channel containing the L and M channels and audio encoding data of a second channel containing the R and S channels.

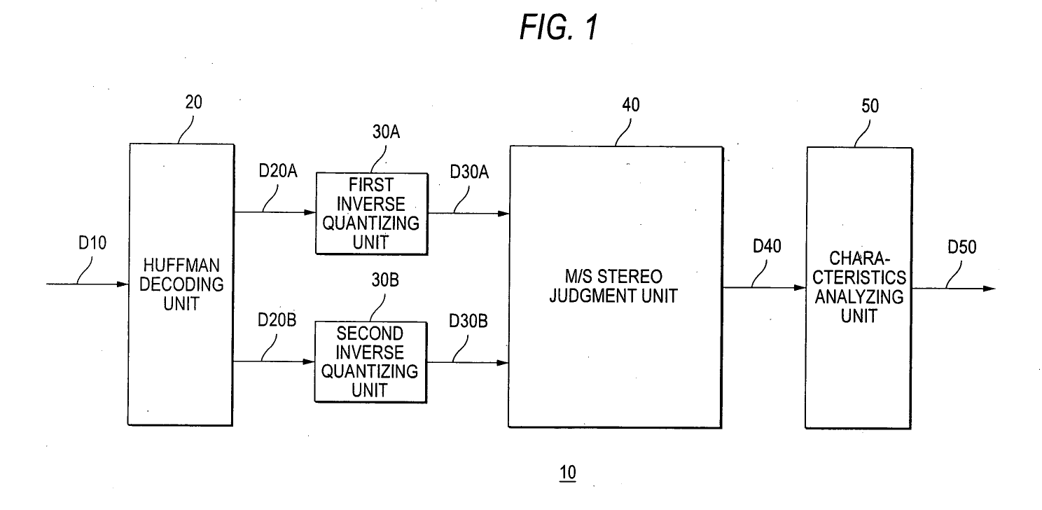

FIG. 1 illustrates a configuration of Audio data processing apparatus 10 according to Embodiment 1 which is provided at decoding apparatus. The audio encoded data D10 generated by the above-described encoding apparatus is received by the Audio data processing apparatus 10 and then inputted into a Huffman decoding unit 20.

The Huffman decoding unit 20 decodes the audio encoded data D10, for example, Huffman decoding, thereby generating frequency domain audio data composed of frequency domain audio data (audio data on frequency axis) D20A of a first channel containing the L and M channels and frequency domain audio data D20B of a second channel containing the R and S channels, and outputting the frequency domain audio data D20A of the first channel to a first inverse quantizing unit 30A, whereas outputting the frequency domain audio data D2B of the second channel to a second inverse quantizing unit 30B.

Incidentally, the frequency domain audio data D20A of the first channel has a plurality of parameters called a scale factor (quantizing step size information), each corresponding to a scale factor band. Similarly, the frequency domain audio data D20B of the second channel also has scale factors, each corresponding to a scale factor band.

Of the first and second inverse quantizing units 30A and 30B constituting the inverse quantizing unit, the inverse quantizing unit 30A generates the frequency domain audio data D30A of the first channel on an ordinary scale by multiplying the frequency domain audio data D20A of the first channel with a scale factor to inversely quantize the frequency domain audio data D20A of the first channel by the unit of scale factor band, thereby outputting the data to an M/S stereo judgment unit 40.

Similarly, the second inverse quantizing unit 30B generates the frequency domain audio data D30B of the second channel on an ordinary scale by multiplying the frequency domain audio data D20B of the second channel with a scale factor by the unit of scale factor band, thereby outputting the data to the M/S stereo judgment unit 40.

The M/S stereo judgment unit 40 uses the frequency domain audio data D30A and D30B of the first and second channels, thereby judging whether it is a scale factor band to which the M/S stereo is applied by each corresponding scale factor band.

In a case of judging that the scale factor band is a scale factor band to which the M/S stereo is applied, the M/S stereo judgment unit 40 selects and outputs the frequency domain audio data of the S channel corresponding to the scale factor band concerned.

In contrast, if the scale factor band is a scale factor band to which the M/S stereo is not applied, the M/S stereo judgment unit 40 calculates a difference between frequency domain audio data of the L channel and that of the R channel corresponding to the scale factor band concerned, which is divided by “2,” thereby generating and outputting the frequency domain audio data of the S channel.

As described above, the M/S stereo judgment unit 40, for each scale factor band, makes a judgment whether the M/S stereo has been applied to the scale factor band and switches the output depending on the judgment result, thereby generating the frequency domain audio data D40 of the S channel and outputting the data to a characteristics selection unit 50.

The characteristics analyzing unit 50 is provided with frequency domain audio data for reference to detect audio data having predetermined frequency/signal level characteristics, for example, cheers of spectators. The characteristics analyzing unit 50 calculates a similarity between the frequency domain audio data for reference and the frequency domain audio data D40 of the S channel, thereby generating an analyzing result signal D50 indicating whether audio data having predetermined frequency/signal level characteristics such as cheers of spectators are contained in input audio encoding data D10, and outputting the signal.

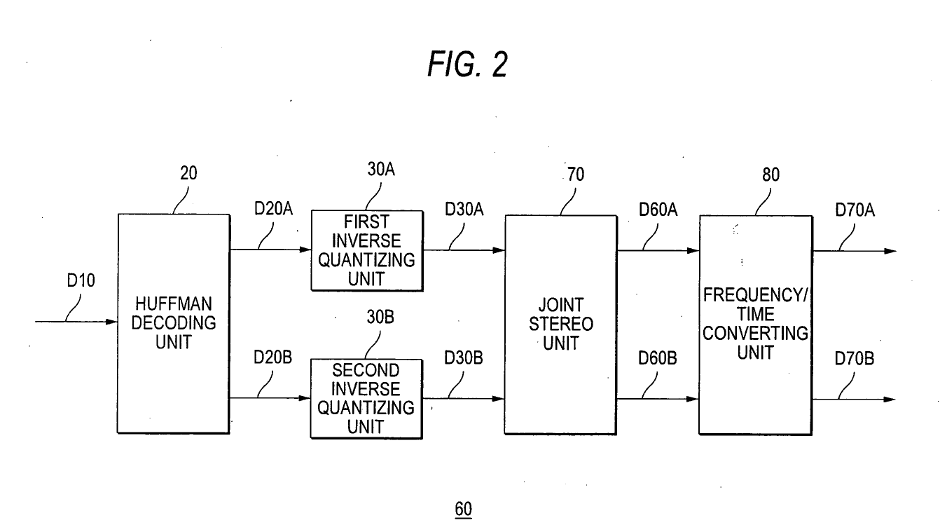

FIG. 2 illustrates an entire configuration of decoding apparatus 60. It is noted that elements which are the same as those in FIG. 1 are given the same reference numerals and the description thereof will be omitted here. In the case of the decoding apparatus 60, a joint stereo unit 70 is given the frequency domain audio data D30A of the first channel from the first inverse quantizing unit 30A and the frequency domain audio data D30B of the second channel from the second inverse quantizing unit 30B.

The joint stereo unit 70 uses the frequency domain audio data D30A and D30B of the first and second channels, thereby making a judgment by every corresponding scale factor band for whether it is a scale factor band to which the M/S stereo is applied.

In a case of judging that the scale factor band is a scale factor band to which the M/S stereo is not applied, the joint stereo unit 70 outputs frequency domain audio data of the L and R channels corresponding to the scale factor band concerned as they are.

In contrast, in a case of judging that it is a scale factor band to which the M/S stereo is applied, the joint stereo unit 70 uses frequency domain audio data of the M and S channels corresponding to the scale factor band, thereby generating and outputting the frequency domain audio data of the L and R channels.

As described above, the joint stereo unit 70 generates the frequency domain audio data D60A of the L channel and the frequency domain audio data D60B of the R channel and outputs the data to a frequency/time converting unit 80.

The frequency/time converting unit 80 gives frequency/time conversion respectively to the frequency domain audio data D60A of the L channel and the frequency domain audio data D60B of the R channel, thereby generating the time domain audio data D70A of the L channel and the time domain audio data D70B of the R channel.

As illustrated in FIG. 2, according to the present embodiment, a characteristics analysis can be made by using the frequency domain audio data D30A and D30B of the first and second channels output from the first and second inverse quantizing units 30A and 30B. Therefore, as compared with a case where the time domain audio data D70A and D70B of the L and R channels output from the frequency/time converting unit 80 are used to make a characteristics analysis or a case where the frequency domain audio data D60A and D60B of the L and R channels output from the joint stereo unit 70 are used to make a characteristics analysis, the characteristics analysis can be made at a shorter time.

### (2) Embodiment 2

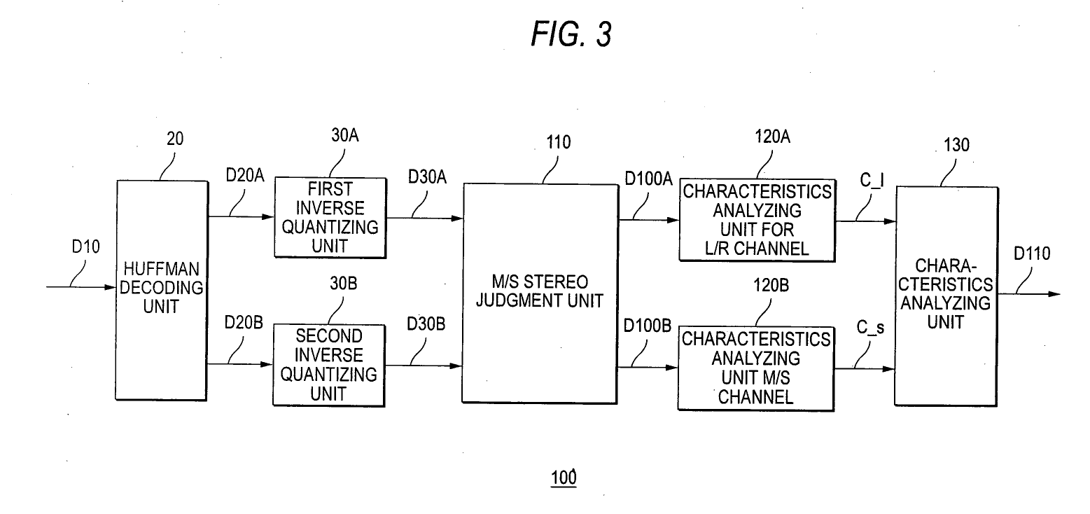

FIG. 3 illustrates a configuration of Audio data processing apparatus 100 according to Embodiment 2. It is noted that elements which are the same as those in FIG. 1 are given the same reference numerals and the description thereof will be omitted here. In the case of the Audio data processing apparatus 100, as with Embodiment 1, an M/S stereo judgment unit 110 uses the frequency domain audio data D30A and D30B of the first and second channels, thereby, for each scale factor band, making a judgment whether the M/S stereo has been applied to the scale factor band.

In a case of judging that the scale factor band is a scale factor band to which the M/S stereo is applied, the M/S stereo judgment unit 110 selects the frequency domain audio data D100B of the S channel corresponding to the scale factor band concerned, outputting it to a characteristics analyzing unit 120B for the M/S channel.

In contrast, in a case of judging that it is a scale factor band to which the M/S stereo is not applied, the M/S stereo judgment unit 110 selects the frequency domain audio data D100A of the L channel corresponding to the scale factor band, outputting it to a characteristics analyzing unit 120A for the L/R channel. It is noted that in this instance, the frequency domain audio data of the R channel may be selected and output.

The characteristics analyzing unit 120A for the L/R channel has the L channel frequency domain audio data for reference, calculating a similarity of C_1 between the L channel frequency domain audio data for reference and the frequency domain audio data D100A of the L channel, outputting it to the characteristics analyzing unit 130.

The characteristics analyzing unit 120B for the M/S channel has the S channel frequency domain audio data for reference, calculating a similarity of C_s between the S channel frequency domain audio data for reference and the frequency domain audio data D100B of the S channel, outputting it to the characteristics analyzing unit 130.

The characteristics analyzing unit 130 uses the given similarities of C_1 and C_s, thereby performing a weighted calculation for weighting the similarity of C_s output from the characteristics analyzing unit 120B for the M/S channel to calculate a similarity of C by referring to the following formula (2):

C=C_{—}s+α·C_{—}1(0≦α≦1) (2).

Then, the characteristics analyzing unit 130 compares the similarity of C with a predetermined threshold value, thereby generating and outputting an analyzing result signal D110 indicating whether the input audio encoded data D10 contains audio data having predetermined frequency/signal level characteristics, for example, cheers of spectators.

As described above, according to the present embodiment, when detected is audio data having the predetermined frequency/signal level characteristics, for example, cheers of spectators, there is a possibility that the frequency domain audio data D100A of the L channel may be kept overlapped with the voice of an announcer or the like. Therefore, the frequency domain audio data D100B of the S channel from which the voice of an announcer or the like is removed is used to weight the calculated similarity of C_s to make a characteristics analysis, by which the characteristics analysis can be made under a decreased influence of the voice of an announcer to improve the accuracy of the characteristics analysis.

Further, according to the present embodiment, as with Embodiment 1, the frequency domain audio data D30A and D30B of the first and second channels output from the first and second inverse quantizing units 30A and 30B are used to make a characteristics analysis, thereby shortening the time necessary for the characteristics analysis.

### (3) Embodiment 3

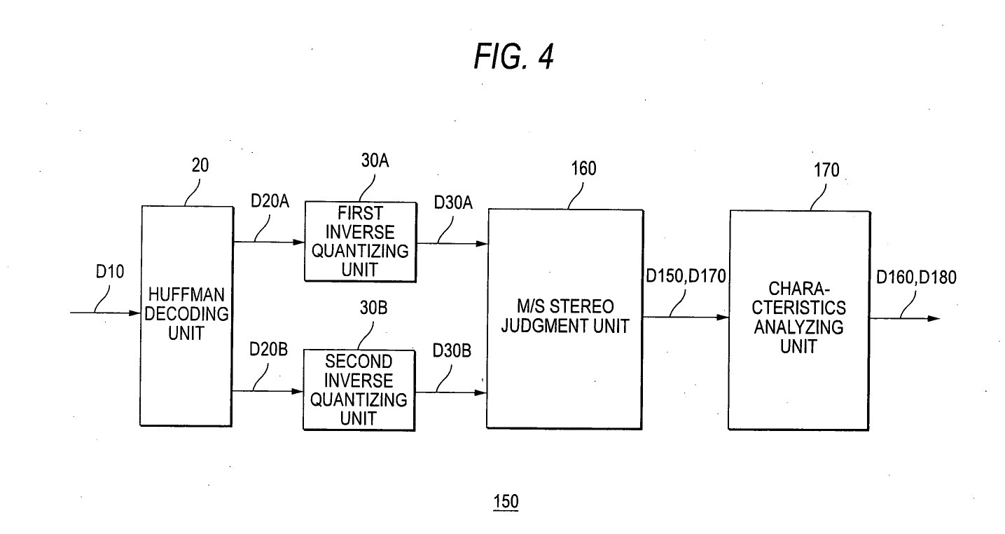

FIG. 4 illustrates a configuration of Audio data processing apparatus 150 according to Embodiment 3. It is noted that elements which are the same as those in FIG. 1 are given the same reference numerals and the description thereof will be omitted here. In the case of the Audio data processing apparatus 150, an M/S stereo judgment unit 160 uses the frequency domain audio data D30A and D30B of the first and second channels, thereby, for each scale factor band, making a judgment whether the M/S stereo is applied to the scale factor band.

Then, if a ratio of the number of scale factor bands (num_ms) to which the M/S stereo is applied in relation to a total number of scale factor bands (num_sfb) is greater than a predetermined threshold value (TH1) as shown in the following formula (3):

$$\frac{num\_ms}{num\_sfb} \geq TH 1 , \qquad ( 3 )$$

the M/S stereo judgment unit 160 judges that the voice of an announcer is mixed.

In this instance, regarding a scale factor band to which the M/S stereo is applied, the M/S stereo judgment unit 160 selects the frequency domain audio data of the S channel corresponding to the scale factor band. Regarding a scale factor band to which the M/S stereo is not applied, the M/S stereo judgment unit 160 uses the frequency domain audio data of the L and R channels corresponding to the scale factor band to generate the frequency domain audio data of the S channel, thereby generating the frequency domain audio data D150 of the S channel in a total frequency band, and outputting it to a characteristics analyzing unit 170.

The characteristics analyzing unit 170 is provided with the S channel frequency domain audio data for reference to detect audio data having predetermined frequency/signal level characteristics, for example, cheers of spectators. The characteristics analyzing unit 170 calculates a similarity between the S channel frequency domain audio data for reference and the frequency domain audio data D150 of the S channel, thereby generating an analyzing result signal D160 indicating whether the audio data having predetermined frequency/signal level characteristics such as cheers of spectators are contained in input audio encoded data D10, and outputting the signal.

In contrast, if a ratio of the number of scale factor bands (num_ms) to which the M/S stereo is applied in relation to a total number of scale factor bands (num_sfb) is lower than a predetermined threshold value (TH2) as shown in the following formula (4):

$$\frac{num\_ms}{num\_sfb} \leq TH 2 , \qquad ( 4 )$$

the M/S stereo judgment unit 160 judges that the voice of an announcer is not mixed.

In this instance, regarding a scale factor band to which the M/S stereo is applied, the M/S stereo judgment unit 160 uses the frequency domain audio data of the M and S channels corresponding to the scale factor band concerned, thereby generating the frequency domain audio data of the L channel. Regarding a scale factor band to which the M/S stereo is not applied, the M/S stereo judgment unit 160 selects the frequency domain audio data of the L channel corresponding to the scale factor band, thereby generating the frequency domain audio data D170 of the L channel in a total frequency band, and outputting it to the characteristics analyzing unit 170. It is noted that in this instance, the frequency domain audio data of the R channel may be generated in place of that of the L channel.

The characteristics analyzing unit 170 is provided with the L channel frequency domain audio data for reference to detect audio data having predetermined frequency/signal level characteristics, for example, cheers of spectators. The characteristics analyzing unit 170 calculates a similarity between the L channel frequency domain audio data for reference and the frequency domain audio data D170 of the L channel, thereby generating an analyzing result signal D180 indicating whether audio data having predetermined frequency/signal level characteristics such as cheers of spectators are contained in input audio encoded data D10, and outputting the signal.

It is noted that where using the above formulae (3) and (4) to make a judgment for whether the voice of an announcer is mixed, the M/S stereo judgment unit 160 can make a judgment by restricting to a frequency band of human voice, for example, the frequency band from 100 Hz to 4 kHz.

As described so far, according to the present embodiment, if the voice of an announcer is judged not to be mixed, the frequency domain audio data D170 of the L channel is used to make a characteristics analysis, thus making it possible to increase the analysis accuracy, as compared with a case where the frequency domain audio data D150 of the S channel is used to make a characteristics analysis.

Further, according to the present embodiment, as with Embodiment 1, the frequency domain audio data D30A and D30B of the first and second channels output from the first and second inverse quantizing units 30A and 30B are used to make a characteristics analysis, thereby shortening the time necessary for the characteristics analysis.

According to the above-described embodiments, the time for making a characteristics analysis of audio data can be shortened.

It should be noted that the above described embodiments are given just as an example and the present invention is not restricted by these embodiments. For example, an audio encoding method may include other various audio encoding methods in which the M/S stereo such as the MP3 is used in place of AAC. Further, audio data to be detected is not restricted to the voices of spectators but may include various types of audio data having predetermined frequency/signal level characteristics.

What is claimed is:

1. An audio data processing apparatus, comprising:
a receiving unit configured to receive an encoded audio data, which contains first data composed of an encoded sum component of audio signals of light and left channels and an encoded difference component of audio signals of the light and left channels, and second encoded data composed of encoded audio signals of right and left channels;
a decoding unit configured to decode the received encoded audio data and output a frequency domain audio data;
an inverse quantizing unit configured to inversely quantize the frequency domain first data and second data contained in the frequency domain audio data;
a detecting unit, for each scale factor band, configured to detect whether M/S stereo mode is applied to the scale factor band;
a generating unit configured to generate a difference component based on a frequency domain difference component contained in the frequency domain first data if the detecting unit detects that the M/S stereo mode is applied to the scale factor band, and generate a difference component by using a frequency domain audio signals of the right and left channels contained in the frequency domain second data if the detecting unit detects that the M/S stereo mode is not applied to the scale factor band; and
an analyzing unit configured to analyze a characteristics of the encoded audio data based on the generated difference component.

2. The audio data processing apparatus according to claim 1, wherein, for each frequency band, the first data is generated if a correlation value between audio signals of light and left channels is less than a correlation threshold.

3. The audio data processing apparatus according to claim 1, wherein the analyzing unit is provided with a frequency domain audio data to be used as reference data having a given signal level, and
wherein the analyzing unit is configured to determine whether the audio data having a given signal level is included in the encoded audio data by analyzing a similarity between the reference data and the generated difference component.

4. The audio data processing apparatus according to claim 1, wherein the analyzing unit is provided with a frequency domain audio data to be used as reference data having a given frequency characteristic, and
wherein the analyzing unit is configured to determine whether the audio data having a given frequency characteristic is included in the encoded audio data by analyzing a similarity between the reference data and the generated difference component.

5. The audio data processing apparatus according to claim 1, wherein the analyzing unit is provided with a frequency domain audio data to be used as reference data having a given signal level and frequency characteristic, and
wherein the analyzing unit is configured to determine whether the audio data having a given signal level and frequency characteristic is included in the encoded audio data by analyzing a similarity between the reference data and the generated difference component.

6. An audio data processing apparatus, comprising:
a receiving unit configured to receive an encoded audio data, which contains first data composed of an encoded sum component of audio signals of light and left channels and an encoded difference component of audio signals of the light and left channels, and second encoded data composed of encoded audio signals of right and left channels;
a decoding unit configured to decode the received encoded audio data and output a frequency domain audio data;
an inverse quantizing unit configured to inversely quantize the frequency domain first data and second data contained in the frequency domain audio data;
a detecting unit, for each scale factor band, configured to detect whether M/S stereo mode is applied to the scale factor band;
a generating unit configured to generate a frequency domain difference component based on a frequency domain difference component contained in the frequency domain first data if the detecting unit detects that the M/S stereo mode is applied to the scale factor band, and generate a frequency domain audio signals of right and left channels if the detecting unit detects that the M/S stereo mode is not applied to the scale factor band; and
an analyzing unit configured to analyze a characteristics of the encoded audio data based on the generated frequency domain difference component for the scale factor band being applied to the M/S stereo mode and analyze a characteristics of the encoded audio data based on the generated frequency domain audio signals of right and left channels for the scale factor band being not applied to the M/S stereo mode.

7. The audio data processing apparatus according to claim 6, wherein, for each frequency band, the first data is generated if a correlation value between audio signals of light and left channels is less than a correlation threshold.

8. The audio data processing apparatus according to claim 6, wherein the analyzing unit is provided with first frequency domain audio data for the M/S stereo mode to be used as first reference data having first signal level and second frequency audio data for the non-M/S stereo mode to be used as second reference data having a second signal level, and
wherein the analyzing unit is configured to determine whether the audio data having a given signal level is included in the encoded audio data by analyzing a similarity between the first reference data and the generated frequency domain difference component and the second reference data and the generated frequency domain audio signals of right and left channels.

9. The audio data processing apparatus according to claim 6, wherein the analyzing unit is provided with first frequency domain audio data for the M/S stereo mode to be used as first reference data having first frequency characteristic and second frequency audio data for the non-M/S stereo mode to be used as second reference data having a second frequency characteristic, and
wherein the analyzing unit is configured to determine whether the audio data having a given frequency characteristic is included in the encoded audio data by analyzing a similarity between the first reference data and the generated frequency domain difference component and the second reference data and the generated frequency domain audio signals of right and left channels.

10. The audio data processing apparatus according to claim 6, wherein the analyzing unit is provided with first frequency domain audio data for the M/S stereo mode to be used as first reference data having first signal level and a first frequency characteristic and second frequency audio data for the non-M/S stereo mode to be used as second reference data having first signal level and a second frequency characteristic, and
wherein the analyzing unit is configured to determine whether the audio data having given signal level and a given frequency characteristic is included in the encoded audio data by analyzing a similarity between the first reference data and the generated frequency domain difference component and the second reference data and the generated frequency domain audio signals of right and left channels.

11. An audio data processing apparatus, comprising:
a receiving unit configured to receive an encoded audio data, which contains first data composed of an encoded sum component of audio signals of light and left channels and an encoded difference component of audio signals of the light and left channels, and second encoded data composed of encoded audio signals of right and left channels;
a decoding unit configured to decode the received encoded audio data and output a frequency domain audio data;
an inverse quantizing unit configured to inversely quantize the frequency domain first data and second data contained in the frequency domain audio data;
a detecting unit, for each scale factor band, configured to detect whether M/S stereo mode is applied to the scale factor band;
generating unit configured to generate a frequency band difference component based on a frequency domain difference component contained in the frequency domain first data if a ratio of a number of the scale factor band to which the M/S stereo mode is applied to a total number of the scale factor band id equal to or greater the a given threshold and generate a frequency domain audio signals of right and left channels if the ratio is lower than the threshold; and
an analyzing unit configured to analyze a characteristics of the encoded audio data based on the frequency domain audio data.

12. The audio data processing apparatus according to claim 11, wherein, for each frequency band, the first data is generated if a correlation value between audio signals of light and left channels is less than a correlation threshold.
